(19) United States
(12) Patent Application Publication
(10) Pub. No.: US 2010/0261592 A1
(43) Pub. Date: Oct. 14, 2010

(54) Tube Plug

(76) Inventor: Kuo-Chang WU, Sanchong City (TW)

Correspondence Address: Muncy, Geissler, Olds & Lowe, PLLC, 4000 Legato Road, Suite 310, FAIRFAX, VA, 22033, US

(21) Appl. No.: 12/179,252

(22) Filed: Jul. 24, 2008

(51) Int. Cl. F16C 13/00

(52) U.S. Cl. 492/15

(57) ABSTRACT

A tube plug is used for a tube wrapped with rollable materials and comprises a support plate, a column, and a positioning part. The column and the positioning part are provided on the same surface of the support plate. Thereby, the length of the wrapped rollable materials can be prevented from increasing when the two openings of the tube are inserted with the tube plug respectively.

### BACKGROUND OF THE INVENTION

1. Field of the Invention

The present invention relates to a tube plug and, more particularly, to a tube plug having a support plate that is provided with a positioning part and a column on the same surface thereof and used for limiting the length of wrapped rollable materials after it is wrapped on the tube.

2. Description of the Prior Art

Conventional device for rolling rollable materials is to wrap various-kind half-finished products or finished products of tapes, roll papers, plastic membranes, or fabric rolls in order to facilitate the storage, transportation, or supply of these products. One common way of rolling these half-finished or finished products is to wind them to form desired cylindrical rolls. Besides, two openings of each roll are inserted with tube plugs. Thereby, these rolls can be piled up and transported conveniently.

As shown in FIG. 4, the tube plug “a” mentioned above has a support plate “a1”. Two surfaces of the support plate “a1” are provided with a folded part “a2” and a hollow cylinder “a3”. The hollow cylinder “a3” is used for insertion into each opening of the roll “b”. Besides, the packaged rolls can be piled up stably by increasing supporting area thereof via the folded part “a2”. However, when in practice, the total length of any packaged roll “b” will be increased because the folded part “a2” is protruded outwardly from two ends of the roll “b”. Consequently, the total amounts of packaged rolls “b” that can be transported will be reduced correspondingly and the rolls “b” will occupy more storage space in a storehouse and reduce the storage capacity thereof. Thereby, the cost will be elevated.

In order to overcome these disadvantages mentioned above to shorten the total length of any packaged roll for decreasing the cost of transportation and storage, inventor had the motive to study and develop the present invention after hard research.

### SUMMARY OF THE INVENTION

One object of the present invention is to provide a tube plug having a support plate, wherein a column and a positioning part are provided on the same surface of the support plate in order to shorten the total length of any packaged roll after tube plugs are inserted into two ends of the roll, so that the cost of transportation and storage can be decreased.

Another object of the present invention is to provide a tube plug having a support plate, wherein a plurality of strengthened ribs are radially arranged on one surface of the support plate, so that packaged rolls can be piled up stably.

In order to achieve the above objects, the present invention provides a tube plug comprising a support plate, a column provided on one surface of the support plate, and a positioning part provided at the peripheries of the support plate. The column and the positioning part are provided on the same surface of the support plate. Thereby, a space for connection with the tube can be formed between the positioning part and the column and the total length of the wrapped rollable materials can be shortened.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is a schematic view of a first embodiment of the present invention showing the assembly of two tube plugs and a tube.

FIG. 2 is a perspective view showing the combination of two tube plugs and the tube.

FIG. 3 is a schematic view of a second embodiment of the present invention showing the assembly of two tube plugs and a tube.

FIG. 4 is a perspective view showing a conventional combination of two tube plugs and a roll.

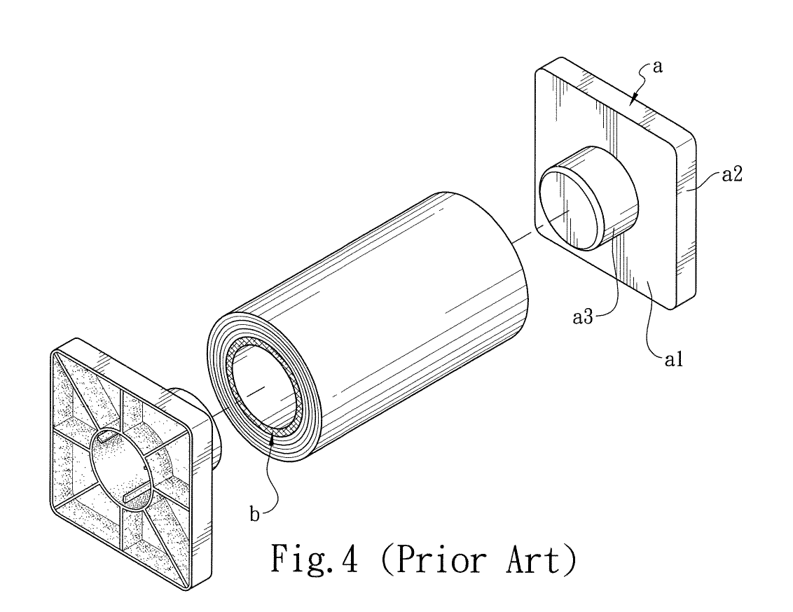

### DETAILED DESCRIPTION OF THE PREFERRED EMBODIMENTS

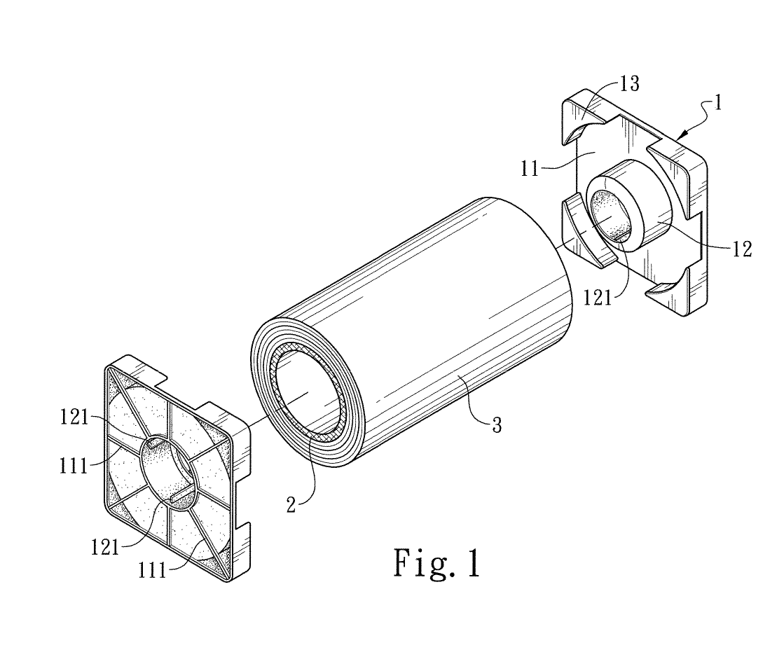

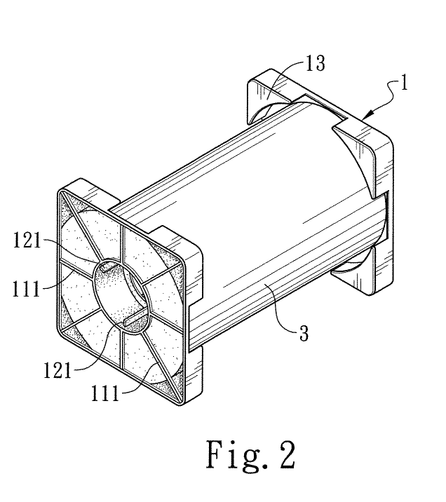

Please refer to FIGS. 1 and 2 showing a first embodiment of a tube plug 1 of the present invention. The tube plug 1 comprises a support plate 11 and a column 12. The column 12 is a hollow cylinder and is disposed on one surface of the support plate 11.

The support plate 11 is quadrilateral and provided with a positioning part 13 at four peripheral corners thereof. The support plate 11 has a certain width and the positioning part 13 and the column 12 are disposed on the same surface of the support plate 11.

In practice, the column 12 of the tube plug 1 is inserted into each end of the tube 2 (such as a cylindrical paper tube) wrapped with rollable materials. Thereby, each end of the tube 2 wrapped with the rollable materials 3 (such as tapes, roll papers, plastic membranes, or fabric rolls) can be located in a space formed between the positioning part 13 and the column 12. The diameter of the column 12 is slightly smaller than the internal diameter of the tube 2, so that the column 12 can be positioned within each end of the tube 2 when the column 12 is inserted therein.

Besides, a plurality of the strengthened ribs 121 is radially arranged on another surface of the support plate 11. Moreover, the internal peripheries of the column 12 are provided with a plurality of strengthened ribs 111. Thereby, better supporting force can be provided to strengthen the structure of the tube plug 1 and consequently large amounts of tubes 2 wrapped with rollable materials 3 can be piled up together.

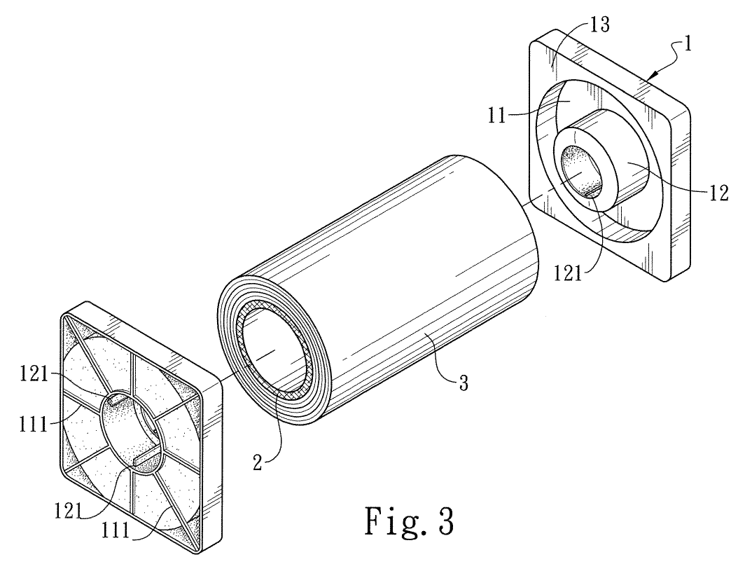

Please refer to FIGS. 3 showing a second embodiment of a tube plug 1 according to the present invention. In this embodiment, the peripheries of the support plate 11 are provided with a positioning part 13. The positioning part 13 and the column 12 are provided on the same surface of the support plate 11. The internal peripheries of the positioning part 13 are in circular shape. Thus, each end of the tube 2 wrapped with rollable materials 3 can be located within a space between the positioning part 13 and the column 12, so that the rollable materials 3 can be held stably.

Therefore, the present invention has the following advantages:
1. By disposing the positioning part and the column on the same surface of the support plate of the tube plug according to the present invention, the total length of the wrapped rollable materials can be shortened, so that more amounts of tubes wrapped with rollable materials can be transported during each transportation process, the storage capacity of a storage house can be increased, and the cost can be reduced.
2. The size and the shape of the internal peripheries of the protruded part of the positioning part can be changed according to predetermined thickness and shape of the rollable materials. Besides, the size and shape of the column also can be changed according to the diameters and shapes of tubes in order to hold the wrapped rollable materials. Thereby, the tube plug according to the present invention can be applied widely to various devices for wrapping rollable materials.

Accordingly, as disclosed in the above description and attached drawings, the present invention can provide a tube plug, by using which the total length of the rollable materials wrapping the tube can be shortened and thus the rollable materials can be stored and transported conveniently. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A tube plug used for a tube wrapped with rollable materials, comprising a support plate and a column that is provided on one surface of the support plate and is used to be inserted into an opening of the tube; the tube plug characterized in that:
a positioning part is provided at peripheries of the support plate and protruded from the surface of the support plate where the column is disposed, so that a space is formed between the column and the positioning part for connection with the tube.

2. The tube plug as claimed in claim 1, wherein the support plate is quadrilateral.

3. The tube plug as claimed in claim 1, wherein a plurality of strengthened ribs are further radially arranged on another surface of the support plate.

4. The tube plug as claimed in claim 1, wherein the column is a hollow column.

5. The tube plug as claimed in claim 4, wherein a plurality of strengthened ribs are further provided on internal peripheries of the column.
